(19) United States
(12) Patent Application Publication
(10) Pub. No.: US 2004/0193838 A1
(43) Pub. Date: Sep. 30, 2004

(54) Vector instructions composed from scalar instructions

(76) Inventors: Patrick Devaney, Haverhill, MA (US); David M. Keaton, Boulder, CO (US); Katsumi Murai, Moriguchi-City (JP)

Correspondence Address: RATNERPRESTIA, P O BOX 980, VALLEY FORGE, PA, 19482-0980, US

(21) Appl. No.: 10/403,241

(22) Filed: Mar. 31, 2003

(51) Int. Cl. G06F 15/00

(52) U.S. Cl. 712/3

(57) ABSTRACT

A processing system includes left and right data path processors configured to execute instructions issued from an instruction cache. A vector instruction includes a first word configured for execution by the left data path processor and a second word configured for execution by the right data path processor. The first and second words are issued in the same clock cycle from the instruction cache, and are interlocked to jointly specify a single vector instruction. The first and second words include code for vector operation and code for vector control. The first and second words are concurrently executed to complete the vector operation, free-of any other instructions issued from the instruction cache.

### TECHNICAL FIELD

The present invention relates, in general, to data processing systems and, more specifically, to data processing systems having an instruction set architecture (ISA) extended to include vector instructions composed from scalar instructions.

### BACKGROUND OF THE INVENTION

Vector processing systems include special purpose vector instructions for performing consecutive sequences of operations using pipelined execution units. Since multiple operations are implied by a single vector instruction, vector processing systems require fewer instructions to be fetched and decoded by the hardware. Vector processing reduces the frequency of branch instructions since the vector instructions themselves specify repetition of processing operations on different data elements.

Conventional processing systems incorporate a dedicated vector register set and a separate vector instruction set for operating on vector data. A separate vector functional unit that includes an arithmetic pipeline is used for operating on vector elements. Such a vector functional unit duplicates the capabilities of a scalar pipeline of a general purpose system.

U.S. Pat. No. 5,537,606, issued Jul. 16, 1996 to Byrne, discloses a processing system that performs vector operations using scalar machine resources. The processing system incorporates multiple parallel scalar execution unit pipelines, which do not contain hardware dedicated to vector instructions, vector registers, or vector execution controls. The processing system uses scalar instructions to perform vector operations, if a vector mode is indicated in the processor controls. This patent, however, discloses the addition of an external vector length register and an external vector count register that must be explicitly loaded. Since these registers must be explicitly loaded, vector instruction issue and context switching is complicated. For example, a non-zero value for vector count indicates that the instruction is a vector instruction.

U.S. Pat. No. 5,261,113, issued Nov. 9, 1993 to Jouppi, discloses a technique for using a shared register file to store vector operands as well as scalar operands. Data in the register file is directly accessible for both vector operations and scalar operations. The shared register file is fixed in size by the fields used to address the file, thereby limiting the size of vector operands that may be addressed. Multiple operations are pipelined through a single pipelined execution unit to achieve one result per cycle under control of a single vector instruction. A new instruction format supporting vector operations includes fields to identify each operand as vector or scalar, and to specify the vector length. This disclosure also identifies a new vector instruction format having a 32-bit instruction word. An instruction format using a 32-bit word, however, often lacks vector performance features, such as strides, vector count and mask registers. Jouppi, for example, does not include stride capability in his vector instruction, does not have vector load/store instructions, and limits the vector count to 4 bits.

### SUMMARY OF THE INVENTION

To meet this and other needs, and in view of its purposes, the present invention provides a vector instruction for a processing system. The processing system includes left and right data path processors configured to execute instructions issued from an instruction cache. The vector instruction includes a first word configured for execution by the left data path processor, and a second word configured for execution by the right data path processor. The first and second words are issued in the same clock cycle from the instruction cache, and are interlocked to jointly specify a single vector instruction. The first and second words include code for vector operation and code for vector control. The first and second words are concurrently executed to complete the vector operation, free-of any other instructions issued from the instruction cache.

In another embodiment, the invention includes an instruction set architecture (ISA) for executing vector and scalar operations for a processing system having at least first and second processors. The ISA includes first instruction words configured for execution by the first processor, and second instruction words configured for execution by the second processor.

Each of the first and second instruction words are configured as an independent scalar operation for separate execution by each of the first and second processors, and each of the first and second instruction words are interlocked together as a vector operation for joint execution by each of the first and second processors. When executing scalar operations, the first and second processors use the first and second instruction words to concurrently execute two independent scalar operations. When executing vector operations, the first and second processors interlock the first and second instruction words to execute a single vector operation.

The invention also includes a method of modifying a reduced instruction set computer (RISC) architecture having multiple scalar instruction groups for executing scalar operations into a vector instruction group for executing vector operations The method includes the steps of: (a) defining a first instruction word belonging in a first scalar instruction group as half of a vector single-instruction-multiple-data (SIMD) operation code, in which the operation code determines a sub-word parallelism size (SWPSz); (b) adding bitfields to the first instruction word, the bitfields representing two source operands and one destination operand; (c) deleting bitfields representing two source operands and one destination operand from a second instruction word belonging in a second scalar instruction group; (d) defining vector control bitfields for a vector operation; (e) substituting the vector control bitfields defined in step (d) for the bitfields deleted in step (c); and (f) interlocking together the first instruction word and the second instruction word to form a double word for executing a vector instruction.

It is understood that the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a block diagram of a central processing unit (CPU), showing a left data path processor and a right data path processor incorporating an embodiment of the invention;

FIG. 2 is a block diagram of the CPU of FIG. 1 showing in detail the left data path processor and the right data path processor, each processor communicating with a register file, a local memory, a first-in-first-out (FIFO) system and a main memory, in accordance with an embodiment of the invention;

FIG. 3 is a block diagram of a multiprocessor system including multiple CPUs of FIG. 1 showing a processor core (left and right data path processors) communicating with left and right external local memories, a main memory and a FIFO system, in accordance with an embodiment of the invention;

FIG. 4 is a block diagram of a multiprocessor system showing a level-one local memory including pages being shared by a left CPU and a right CPU, in accordance with an embodiment of the invention;

FIGS. 5a-5c depict formats of various instructions, each instruction defined by a 32-bit word;

FIG. 5d depicts a portion of a vector instruction, specifically showing definitions of 27 bits in a 32-bit word that is executed by a left data path processor, in accordance with an embodiment of the invention;

FIGS. 6a-6b depict, respectively, two 32-bit instruction words that are aligned side-by-side, in order to show a comparison between an instruction word containing a scalar operation code (opcode) and an instruction word containing a vector operation code (vector opcode), in accordance with an embodiment of the invention;

FIG. 7 shows, in tabular format, the “op3” bitfields defining scalar instructions and new vector instructions, with non-condition code (cc) instructions underlined once, and cc instructions underlined twice, in accordance with an embodiment of the invention;

FIG. 8 is a schematic block diagram of a decoding circuit for mapping 5-bits, representing the vopcode of a vector instruction, into 6-bits, representing the opcode of a scalar instruction, in accordance with an embodiment of the invention;

FIG. 9 is a schematic block diagram of another decoding circuit for mapping a bitfield, representing the vopcode of a vector instruction, into 6-bits, representing the opcode of a scalar instruction, in accordance with an embodiment of the invention; and

FIG. 10 depicts a vector load/store instruction, defined in a 32-bit word, in accordance with an embodiment of the invention.

### DETAILED DESCRIPTION OF THE INVENTION

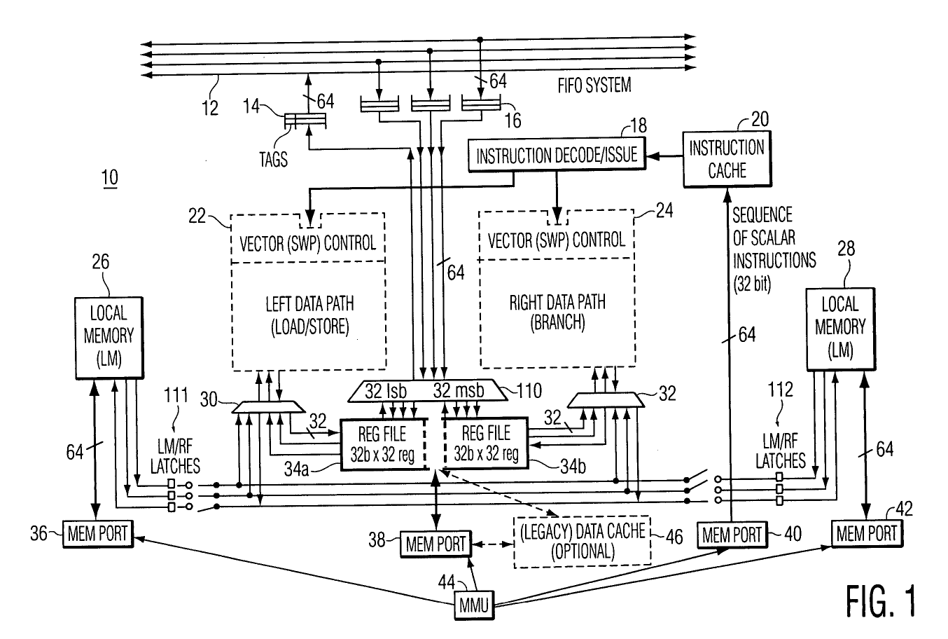

Referring to FIG. 1, there is shown a block diagram of a central processing unit (CPU), generally designated as 10. CPU 10 is a two-issue-super-scalar (2i-SS) instruction processor-core capable of executing multiple scalar instructions simultaneously or executing one vector instruction. A left data path processor, generally designated as 22, and a right data path processor, generally designated as 24, receive scalar or vector instructions from instruction decoder 18.

Instruction cache 20 stores read-out instructions, received from memory port 40 (accessing main memory), and provides them to instruction decoder 18. The instructions are decoded by decoder 18, which generates signals for the execution of each instruction, for example signals for controlling sub-word parallelism (SWP) within processors 22 and 24 and signals for transferring the contents of fields of the instruction to other circuits within these processors.

CPU 10 includes an internal register file which, when executing multiple scalar instructions, is treated as two separate register files 34a and 34b, each containing 32 registers, each having 32 bits. This internal register file, when executing a vector instruction, is treated as 32 registers, each having 64 bits. Register file 34 has four 32-bit read and two write (4R/2W) ports. Physically, the register file is 64 bits wide, but it is split into two 32-bit files when processing scalar instructions.

When processing multiple scalar instructions, two 32-bit wide instructions may be issued in each clock cycle. Two 32-bit wide data may be read from register file 32 from left data path processor 22 and right data path processor 24, by way of multiplexers 30 and 32. Conversely, 32-bit wide data may be written to register file 32 from left data path processor 22 and right data path processor 24, by way of multiplexers 30 and 32. When processing one vector instruction, the left and right 32 bit register files and read/write ports are joined together to create a single 64-bit register file that has two 64-bit read ports and one write port (2R/1W).

CPU 10 includes a level-one local memory (LM) that is externally located of the core-processor and is split into two halves, namely left LM 26 and right LM 28. There is one clock latency to move data between processors 22, 24 and left and right LMs 26, 28. Like register file 34, LM 26 and 28 are each physically 64 bits wide.

It will be appreciated that in the 2i-SS programming model, as implemented in the Sparc architecture, two 32-bit wide instructions are consumed per clock. It may read and write to the local memory with a latency of one clock, which is done via load and store instructions, with the LM given an address in high memory. The 2i-SS model may also issue pre-fetching loads to the LM. The SPARC ISA has no instructions or operands for LM. Accordingly, the LM is treated as memory, and accessed by load and store instructions. When vector instructions are issued, on the other hand, their operands may come from either the LM or the register file (RF). Thus, up to two 64-bit data may be read from the register file, using both multiplexers (30 and 32) working in a coordinated manner. Moreover, one 64 bit datum may also be written back to the register file. One superscalar instruction to one data path may move a maximum of 32 bits of data, either from the LM to the RF (a load instruction) or from the RF to the LM (a store instruction).

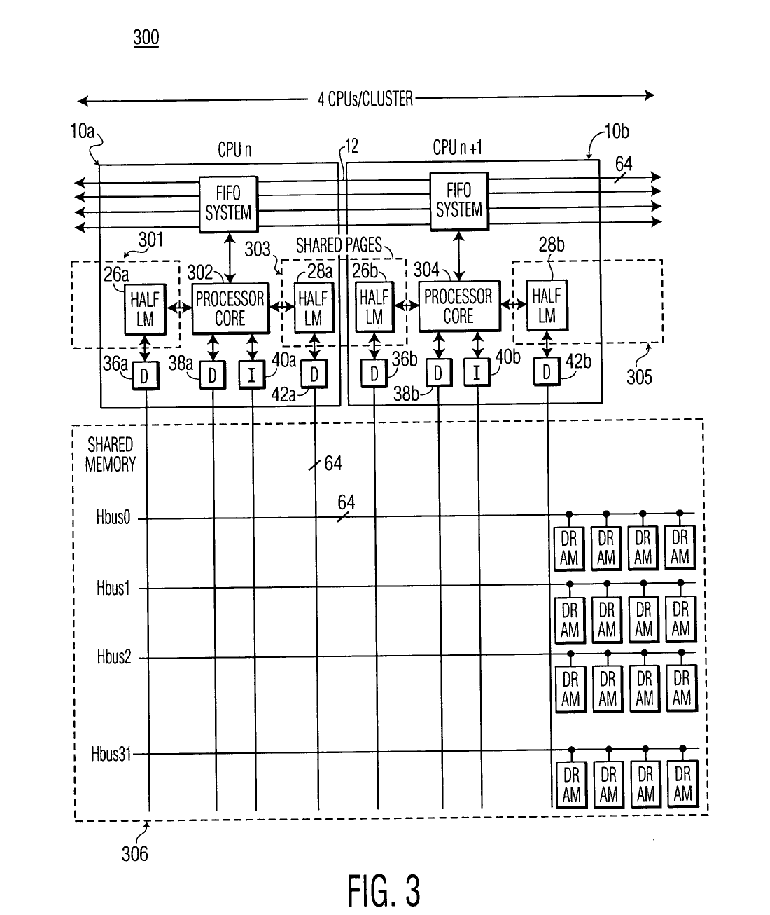

Four memory ports for accessing a level-two main memory of dynamic random access memory (DRAM) (as shown in FIG. 3) are included in CPU 10. Memory port 36 provides 64-bit data to or from left LM 26. Memory port 38 provides 64-bit data to or from register file 34, and memory port 42 provides data to or from right LM 28. 64-bit instruction data is provided to instruction cache 20 by way of memory port 40. Memory management unit (MMU) 44 controls loading and storing of data between each memory port and the DRAM. An optional level-one data cache, such as SPARC legacy data cache 46, may be accessed by CPU 10. In case of a cache miss, this cache is updated by way of memory port 38 which makes use of MMU 44.

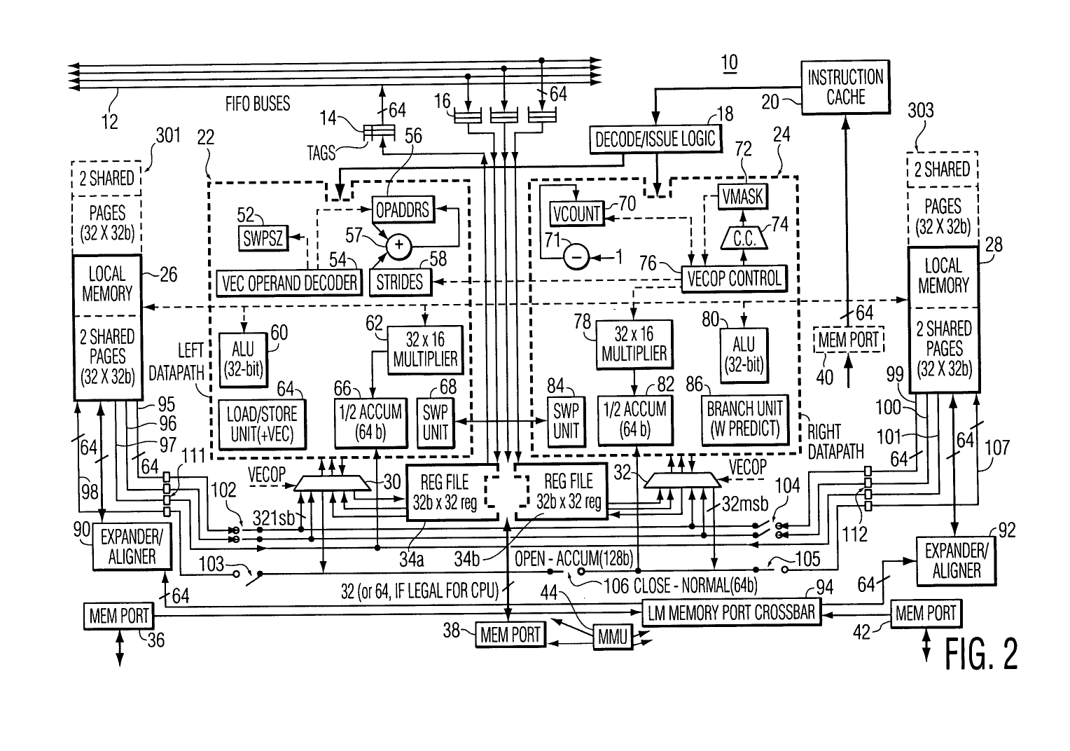

CPU 10 may issue two kinds of instructions: scalar and vector. Using instruction level parallelism (ILP), two independent scalar instructions may be issued to left data path processor 22 and right data path processor 24 by way of memory port 40. In scalar instructions, operands may be delivered from register file 34 and load/store instructions may move 32-bit data from/to the two LMs. In vector instructions, combinations of two separate instructions define a single vector instruction, which may be issued to both data paths under control of a vector control unit (as shown in FIG. 2). In vector instruction, operands may be delivered from the LMs and/or register file 34. Each scalar instruction processes 32 bits of data, whereas each vector instruction may process N×64 bits (where N is the vector length).

CPU 10 includes a first-in first-out (FIFO) buffer system having output buffer FIFO 14 and three input buffer FIFOs 16. The FIFO buffer system couples CPU 10 to neighboring CPUs (as shown in FIG. 3) of a multiprocessor system by way of multiple busses 12. The FIFO buffer system may be used to chain consecutive vector operands in a pipeline manner. The FIFO buffer system may transfer 32-bit or 64-bit instructions/operands from CPU 10 to its neighboring CPUs. The 32-bit or 64-bit data may be transferred by way of bus splitter 110.

Referring next to FIG. 2, CPU 10 is shown in greater detail. Left data path processor 22 includes arithmetic logic unit (ALU) 60, half multiplier 62, half accumulator 66 and sub-word processing (SWP) unit 68. Similarly, right data path processor 24 includes ALU 80, half multiplier 78, half accumulator 82 and SWP unit 84. ALU 60, 80 may each operate on 32 bits of data and half multiplier 62, 78 may each multiply 32 bits by 16 bits, or 2×16 bits by 16 bits. Half accumulator 66, 82 may each accumulate 64 bits of data and SWP unit 68, 84 may each process 8 bit, 16 bit or 32 bit quantities.

Non-symmetrical features in left and right data path processors include load/store unit 64 in left data path processor 22 and branch unit 86 in right data path processor 24. With a two-issue super scalar instruction, for example, provided from instruction decoder 18, the left data path processor includes instruction to the load/store unit for controlling read/write operations from/to memory, and the right data path processor includes instructions to the branch unit for branching with prediction. Accordingly, load/store instructions may be provided only to the left data path processor, and branch instructions may be provided only to the right data path processor.

For vector instructions, some processing activities are controlled in the left data path processor and some other processing activities are controlled in the right data path processor. As shown, left data path processor 22 includes vector operand decoder 54 for decoding source and destination addresses and storing the next memory addresses in operand address buffer 56. The current addresses in operand address buffer 56 are incremented by strides adder 57, which adds stride values stored in strides buffer 58 to the current addresses stored in operand address buffer 56.

It will be appreciated that vector data include vector elements stored in local memory at a predetermined address interval. This address interval is called a stride. Generally, there are various strides of vector data. If the stride of vector data is assumed to be “L”, then vector data elements are stored at consecutive storage addresses. If the stride is assumed to be “8”, then vector data elements are stored 8 locations apart (e.g. walking down a column of memory registers, instead of walking across a row of memory registers). The stride of vector data may take on other values, such as 2 or 4.

Vector operand decoder 54 also determines how to treat the 64 bits of data loaded from memory. The data may be treated as two-32 bit quantities, four-16 bit quantities or eight-8 bit quantities. The size of the data is stored in sub-word parallel size (SWPSZ) buffer 52.

The right data path processor includes vector operation (vecop) controller 76 for controlling each vector instruction. A condition code (CC) for each individual element of a vector is stored in cc buffer 74. A CC may include an overflow condition or a negative number condition, for example. The result of the CC may be placed in vector mask (Vmask) buffer 72.

It will be appreciated that vector processing reduces the frequency of branch instructions, since vector instructions themselves specify repetition of processing operations on different vector elements. For example, a single instruction may be processed up to 64 times (e.g. loop size of 64). The loop size of a vector instruction is stored in vector count (Vcount) buffer 70 and is automatically decremented by “1” via subtractor 71. Accordingly, one instruction may cause up to 64 individual vector element calculations and, when the Vcount buffer reaches a value of “0”, the vector instruction is completed. Each individual vector element calculation has its own CC.

It will also be appreciated that because of sub-word parallelism capability of CPU 10, as provided by SWPSZ buffer 52, one single vector instruction may process in parallel up to 8 sub-word data items of a 64 bit data item. Because the mask register contains only 64 entries, the maximum size of the vector is forced to create no more SWP elements than the 64 which may be handled by the mask register. It is possible to process, for example, up to 8×64 elements if the operation is not a CC operation, but then there may be potential for software-induced error. As a result, the invention limits the hardware to prevent such potential error.

Turning next to the internal register file and the external local memories, left data path processor 22 may load/store data from/to register file 34a and right data path processor 24 may load/store data from/to register file 34b, by way of multiplexers 30 and 32, respectively. Data may also be loaded/stored by each data path processor from/to LM 26 and LM 28, by way of multiplexers 30 and 32, respectively. During a vector instruction, two-64 bit source data may be loaded from LM 26 by way of busses 95, 96, when two source switches 102 are closed and two source switches 104 are opened. Each 64 bit source data may have its 32 least significant bits (LSB) loaded into left data path processor 22 and its 32 most significant bits (MSB) loaded into right data path processor 24. Similarly, two-64 bit source data may be loaded from LM 28 by way of busses 99, 100, when two source switches 104 are closed and two source switches 102 are opened.

Separate 64 bit source data may be loaded from LM 26 by way of bus 97 into half accumulators 66, 82 and, simultaneously, separate 64 bit source data may be loaded from LM 28 by way of bus 101 into half accumulators 66, 82. This provides the ability to preload a total of 128 bits into the two half accumulators.

Separate 64-bit destination data may be stored in LM 28 by way of bus 107, when destination switch 105 and normal/accumulate switch 106 are both closed and destination switch 103 is opened. The 32 LSB may be provided by left data path processor 22 and the 32 MSB may be provided by right data path processor 24. Similarly, separate 64-bit destination data may be stored in LM 26 by way of bus 98, when destination switch 103 and normal/accumulate switch 106 are both closed and destination switch 105 is opened. The load/store data from/to the LMs are buffered in left latches 111 and right latches 112, so that loading and storing may be performed in one clock cycle.

If normal/accumulate switch 106 is opened and destination switches 103 and 105 are both closed, 128 bits may be simultaneously written out from half accumulators 66, 82 in one clock cycle. 64 bits are written to LM 26 and the other 64 bits are simultaneously written to LM 28.

LM 26 may read/write 64 bit data from/to DRAM by way of LM memory port crossbar 94, which is coupled to memory port 36 and memory port 42. Similarly, LM 28 may read/write 64 bit data from/to DRAM. Register file 34 may access DRAM by way of memory port 38 and instruction cache 20 may access DRAM by way of memory port 40. MMU 44 controls memory ports 36, 38, 40 and 42.

Disposed between LM 26 and the DRAM is expander/aligner 90 and disposed between LM 28 and the DRAM is expander/aligner 92. Each expander/aligner may expand (duplicate) a word from DRAM and write it into an LM. For example, a word at address 3 of the DRAM may be duplicated and stored in LM addresses 0 and 1. In addition, each expander/aligner may take a word from the DRAM and properly align it in a LM. For example, the DRAM may deliver 64 bit items which are aligned to 64 bit boundaries. If a 32 bit item is desired to be delivered to the LM, the expander/aligner automatically aligns the delivered 32 bit item to 32 bit boundaries.

External LM 26 and LM 28 will now be described by referring to FIGS. 2 and 3. Each LM is physically disposed externally of and in between two CPUs in a multiprocessor system. As shown in FIG. 3, multiprocessor system 300 includes 4 CPUs per cluster (only two CPUs shown). CPUn is designated 10a and CPUn+1 is designated 10b. CPUn includes processor-core 302 and CPUn+1 includes processor-core 304. It will be appreciated that each processor-core includes a left data path processor (such as left data path processor 22) and a right data path processor (such as right data path processor 24).

A whole LM is disposed between two CPUs. For example, whole LM 301 is disposed between CPUn and CPUn−1 (not shown), whole LM 303 is disposed between CPUn and CPUn+1, and whole LM 305 is disposed between CPUn+1 and CPUn+2 (not shown). Each whole LM includes two half LMs. For example, whole LM 303 includes half LM 28a and half LM 26b. By partitioning the LMs in this manner, processor core 302 may load/store data from/to half LM 26a and half LM 28a. Similarly, processor core 304 may load/store data from/to half LM 26b and half LM 28b.

As shown in FIG. 2, whole LM 301 includes 4 pages, with each page having 32×32 bit registers. Processor core 302 (FIG. 3) may typically access half LM 26a on the left side of the core and half LM 28a on the right side of the core. Each half LM includes 2 pages. In this manner, processor core 302 and processor core 304 may each access a total of 4 pages of LM.

It will be appreciated, however, that if processor core 302 (for example) requires more than 4 pages of LM to execute a task, the operating system may assign to processor core 302 up to 4 pages of whole LM 301 on the left side and up to 4 pages of whole LM 303 on the right side. In this manner, CPUn may be assigned 8 pages of LM to execute a task, should the task so require.

Completing the description of FIG. 3, busses 12 of each FIFO system of CPUn and CPUn+1 corresponds to busses 12 shown in FIG. 2. Memory ports 36a, 38a, 40a and 42a of CPUn and memory ports 36b, 38b, 40b and 42b of CPUn+1 correspond, respectively, to memory ports 36, 38, 40 and 42 shown in FIG. 2. Each of these memory ports may access level-two memory 306 including a large crossbar, which may have, for example, 32 busses interfacing with a DRAM memory area. A DRAM page may be, for example, 32 K Bytes and there may be, for example, up to 128 pages per 4 CPUs in multiprocessor 300. The DRAM may include buffers plus sense-amplifiers to allow a next fetch operation to overlap a current read operation.

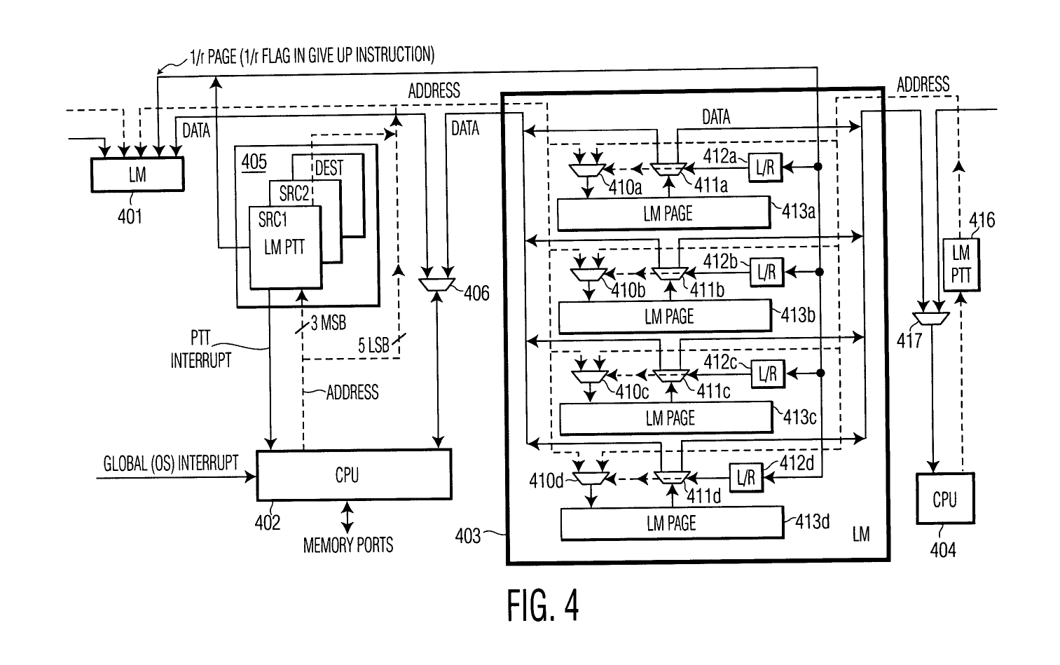

Referring next to FIG. 4, there is shown multiprocessor system 400 including CPU 402 accessing LM 401 and LM 403. It will be appreciated that LM 403 may be cooperatively shared by CPU 402 and CPU 404. Similarly, LM 401 may be shared by CPU 402 and another CPU (not shown). In a similar manner, CPU 404 may access LM 403 on its left side and another LM (not shown) on its right side.

LM 403 includes pages 413a, 413b, 413c and 413d. Page 413a may be accessed by CPU 402 and CPU 404 via address multiplexer 410a, based on left/right (L/R) flag 412a issued by LM page translation table (PTT) control logic 405. Data from page 413a may be output via data multiplexer 411a, also controlled by L/R flag 412a. Page 413b may be accessed by CPU 402 and CPU 404 via address multiplexer 410b, based on left/right (L/R) flag 412b issued by the PTT control logic. Data from page 413b may be output via data multiplexer 411b, also controlled by L/R flag 412b. Similarly, page 413c may be accessed by CPU 402 and CPU 404 via address multiplexer 410c, based on left/right (L/R) flag 412c issued by the PTT control logic. Data from page 413c may be output via data multiplexer 411c, also controlled by L/R flag 412c. Finally, page 413d may be accessed by CPU 402 and CPU 404 via address multiplexer 410d, based on left/right (L/R) flag 412d issued by the PTT control logic. Data from page 413d may be output via data multiplexer 411d, also controlled by L/R flag 412d. Although not shown, it will be appreciated that the LM control logic may issue four additional L/R flags to LM 401.

CPU 402 may receive data from a register in LM 403 or a register in LM 401 by way of data multiplexer 406. As shown, LM 403 may include, for example, 4 pages, where each page may include 32×32 bit registers (for example). CPU 402 may access the data by way of an 8-bit address line, for example, in which the 5 least significant bits (LSB) bypass LM PTT control logic 405 and the 3 most significant bits (MSB) are sent to the LM PTT control logic.

It will be appreciated that CPU 404 includes LM PTT control logic 416 which is similar to LM PTT control logic 405, and data multiplexer 417 which is similar to data multiplexer 406. Furthermore, as will be explained, each LM PTT control logic includes three identical PTTs, so that each CPU may simultaneously access two source operands (SRC1, SRC2) and one destination operand (dest) in the two LMs (one on the left and one on the right of the CPU) with a single instruction.

Moreover, the PTTs make the LM page numbers virtual, thereby simplifying the task of the compiler and the OS in finding suitable LM pages to assign to potentially multiple tasks assigned to a single CPU. As the OS assigns tasks to the various CPUs, the OS also assigns to each CPU only the amount of LM pages needed for a task. To simplify control of this assignment, the LM is divided into pages, each page containing 32×32 bit registers.

An LM page may only be owned by one CPU at a time (by controlling the setting of the L/R flag from the PTT control logic), but the pages do not behave like a conventional shared memory. In the conventional shared memory, the memory is a global resource, and processors compete for access to it. In this invention, however, the LM is architected directly into both processors (CPUs) and both are capable of owning the LM at different times. By making all LM registers architecturally visible to both processors (one on the left and one on the right), the complier is presented with a physically unchanging target, instead of a machine whose local memory size varies from task to task.

A compiled binary may require an amount of LM. It assumes that enough LM pages have been assigned to the application to satisfy the binary's requirements, and that those pages start at page zero and are contiguous. These assumptions allow the compiles to produce a binary whose only constraint is that a sufficient number of pages are made available; the location of these pages does not matter. In actually, however, the pages available to a given CPU depend upon which pages have already been assigned to the left and right neighbor CPUs. In order to abstract away which pages are available, the page translation table is implement by the invention (i.e., the LM page numbers are virtual.)

An abstraction of a LM PTT is shown below.

| Logical | | Physical |
|---|---|---|
| Page | Valid? | Page |
| 0 | Y | 0 |
| 1 | Y | 5 |
| 2 | N | (6) |
| 3 | Y | 4 |

As shown in the table, each entry has a protection bit, namely a valid (or accessible)/not valid (or not accessible) bit. If the bit is set, the translation is valid (page is accessible); otherwise, a fatal error is generated (i.e., a task is erroneously attempting to write to an LM page not assigned to that task). The protection bits are set by the OS at task start time. Only the OS may set the protection bits.

In addition to the protection bits (valid/not valid) (accessible/not accessible) provided in each LM PTT, each physical page of a LM has an owner flag associated with it, indicating whether its current owner is the CPU to its right or to its left. The initial owner flag is set by the OS at task start time. If neither neighbor CPU has a valid translation for a physical page, that page may not be accessed; so the value of its owner bit is moot. If a valid request to access a page comes from a CPU, and the requesting CPU is the current owner, the access proceeds. If the request is valid, but the CPU is not the current owner, then the requesting CPU stalls until the current owner issues a giveup page command for that page. Giveup commands, which may be issued by a user program, toggle the ownership of a page to the opposite processor. Giveup commands are used by the present invention for changing page ownership during a task. Attempting to giveup an invalid (or not accessible) (protected) page is a fatal error.

When a page may be owned by both adjacent processors, it is used cooperatively, not competitively by the invention. There is no arbitration for control. Cooperative ownership of the invention advantageously facilitates double-buffered page transfers and pipelining (but not chaining) of vector registers, and minimizes the amount of explicit signaling. It will be appreciated that, unlike the present invention, conventional multiprocessing systems incorporate writes to remote register files. But, remote writes do not reconfigure the conventional processor's architecture; they merely provide a communications pathway, or a mailbox. The present invention is different from mailbox communications.

At task end time, all pages and all CPUs, used by the task, are returned to the pool of available resources. For two separate tasks to share a page of a LM, the OS must make the initial connection. The OS starts the first task, and makes a page valid (accessible) and owned by the first CPU. Later, the OS starts the second task and makes the same page valid (accessible) to the second CPU. In order to do this, the two tasks have to communicate their need to share a page to the OS. To prevent premature inter-task giveups, it may be necessary for the first task to receive a signal from the OS indicating that the second task has started.

In an exemplary embodiment, a LM PTT entry includes a physical page location (1 page out of possible 8 pages) corresponding to a logical page location, and a corresponding valid/not valid protection bit (Y/N), both provided by the OS. Bits of the LM PTT, for example, may be physically stored in ancillary state registers (ASR's) which the Scalable Processor Architecture (SPARC) allows to be implementation dependent. SPARC is a CPU instruction set architecture (ISA), derived from a reduced instruction set computer (RISC) lineage. SPARC provides special instructions to read and write ASRs, namely rdasr and wrasr.

According to the an embodiment of the architecture, if the physical register is implemented to be only accessible by a privileged user, then a rd/wrasr instruction for that register also requires a privileged user. Therefore, in this embodiment, the PTTs are implemented as privileged write-only registers (write-only from the point of view of the OS). Once written, however, these registers may be read by the LM PTT control logic whenever a reference is made to a LM page by an executing instruction.

The LM PTT may be physically implemented in one of the privileged ASR registers (ASR 8, for example) and written to only by the OS. Once written, a CPU may access a LM via the three read ports of the LM register.

It will be appreciated that the LM PTT of the invention is similar to a page descriptor cache or a translation lookaside buffer (TLB). A conventional TLB, however, has a potential to miss (i.e., an event in which a legal virtual page address is not currently resident in the TLB). In a miss circumstance, the TLB must halt the CPU (by a page fault interrupt), run an expensive miss processing routine that looks up the missing page address in global memory, and then write the missing page address into the TLB. The LM PTT of the invention, on the other hand, only has a small number of pages (e.g. 8) and, therefore, advantageously all pages may reside in the PTT. After the OS loads the PTT, it is highly unlikely for a task not to find a legal page translation. The invention, thus, has no need for expensive miss processing hardware, which is often built into the TLB.

Furthermore, the left/right task owners of a single LM page are similar to multiple contexts in virtual memory. Each LM physical page has a maximum of two legal translations: to the virtual page of its left-hand CPU or to the virtual page of its right hand CPU. Each translation may be stored in the respective PTT. Once again, all possible contexts may be kept in the PTT, so multiple contexts (more than one task accessing the same page) cannot overflow the size of the PTT.

Four flags out of possible eight flags are shown in FIG. 4 as L/R flags 412a-d controlling multiplexers 410a-d and 411a-d, respectively. As shown, CPU 402, 404 (for example) initially sets 8 bits (corresponding to 8 pages per CPU) denoting L/R ownership of LM pages. The L/R flags may be written into a non-privileged register. It will be appreciated that in the SPARC ISA a non-privileged register may be, for example ASR 9.

In operation, the OS handler reads the new L/R flags and sets them in a non privileged register. A task which currently owns a LM page may issue a giveup command. The giveup command specifies which page's ownership is to be transferred, so that the L/R flag may be toggled (for example, L/R flag 412a-d).

As shown, the page number of the giveup is passed through src1 in LM PTT control logic 405 which, in turn, outputs a physical page. The physical page causes a 1 of 8 decoder to write the page ownership (coming from the CPU as an operand of the giveup instruction) to the bit of a non-privileged register corresponding to the decoded physical page. There is no OS intervention for the page transfer. This makes the transfer very fast, without system calls or arbitration.

Having described the multiprocessing system of the invention, an instruction set architecture (ISA), in accordance with an embodiment of the invention, will now be described. SPARC (scalable processor architecture), which is a registered trademark of SPARC International, Inc. is an ISA derived from a reduced instruction set computer (RISC) architecture. SPARC includes 72 basic instruction operations, all encoded in 32-bit wide instruction formats.

The SPARC instructions fall into six basic categories: 1) load/store, 2) arithmetic/logic/shift, 3) control transfer, 4) read/write control register, 5) floating-point operate, and 6) coprocessor operate. Each is discussed below.

Load/store instructions are the only instructions that access memory. The instructions use two r-registers, or an r-register and a signed 13-bit immediate value to calculate a 32-bit, byte-aligned memory address. The processor appends to this address an ASI (address space identifier) that encodes whether the processor is in a supervisor mode or a user mode, and that the instruction is a data access.

It will be appreciated that the processor may be in either of two modes, namely user mode or supervisor mode. In supervisor mode, the processor executes any instruction, including the privileged (supervisor-only) instructions. In user mode, an attempt to execute a privileged instruction causes a trap to supervisor software. User application programs are programs that execute while the processor is in the user mode.

The arithmetic/logical/shift instructions perform arithmetic, tagged arithmetic, logical, and shift operations. With one exception, these instructions compute a result that is a function of two source operands; the result is either written into a destination register, or discarded. The exception is a specialized instruction, SETHI (set high), which (along with a second instruction) may be used to create a 32-bit constant in an r-register.

Shift instructions may be used to shift the contents of an r-register left or right by a given number of bits. The amount of shift may be specified by a constant in the instruction or by the contents of an r-register.

The integer multiply instructions perform a signed or unsigned 32×32 to 64-bit operation. The integer division instructions perform a signed or unsigned 64÷32 to 32-bit operation.

The tagged arithmetic instructions assume that the least-significant 2 bits of the operands are data-type tags. These instructions set the overflow condition code (cc) bit upon arithmetic overflow, or if any of the operands' tag bits are nonzero.

Control-transfer instructions (CTIs) include program counter (PC) relative branches and calls, register-indirect jumps, and conditional traps. Most of the control-transfer instructions are delayed control-transfer instructions (DCTIs), where the instruction immediately following the DCTI is executed before the control transfer to the target address is completed.

The instruction following a delayed control-transfer instruction is called a delay instruction. The delay instruction is always fetched, even if the delayed control transfer is an unconditional branch. However, a bit in the delayed control transfer instruction may cause the delay instruction to be annulled (that is, to have no effect) if the branch is not taken (or in the branch always case, if the branch is taken).

Branch and call instructions use PC-relative displacements. The jump and link (JMPL) instruction uses a register-indirect target address. The instruction computes its target address as either the sum of two r-registers, or the sum of an r-register and a 13-bit signed immediate value. The branch instruction provides a displacement of ±8 Mbytes, while the call instruction's 30-bit word displacement allows a control transfer to an arbitrary 32-bit instruction address.

The read/write state register instructions read and write the contents of software-visible state/status registers. There are also read/write ancillary state registers (ASRs) instructions that software may use to read/write unique implementation-dependent processor registers. Whether each of these instructions is privileged or not privileged is implementation-dependent.

Floating-point operate (FPop) instructions perform all floating-point calculations. They are register-to-register instructions that operate upon the floating-point registers. Like arithmetic/logical/shift instructions, FPops compute a result that is a function of one or two source operands. Specific floating-point operations may be selected by a subfield of the FPop1/FPop2 instruction formats.

The instruction set includes support for a single, implementation-dependent coprocessor. The coprocessor has its own set of registers, the actual configuration of which is implementation-defined, but is nominally some number of 32-bit registers. Coprocessor load/store instructions are used to move data between the coprocessor registers and memory. For each floating-point load/store in the instruction set, there is an analogous coprocessor load/store instruction. Coprocessor operate (CPop) instructions are defined by the implemented coprocessor, if any. These instructions are specified by the CPop1 and CPop2 instruction formats.

Additional description of the SPARC ISA may be found in the SPARC Architecture Manual (Version 8), printed 1992 by SPARC International, Inc., which is incorporated herein by reference in its entirety.

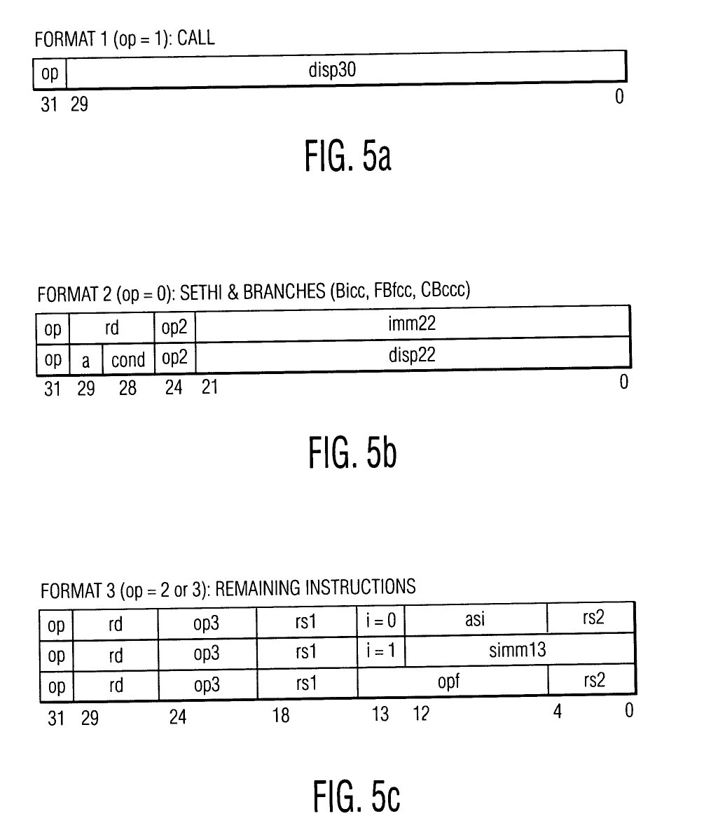

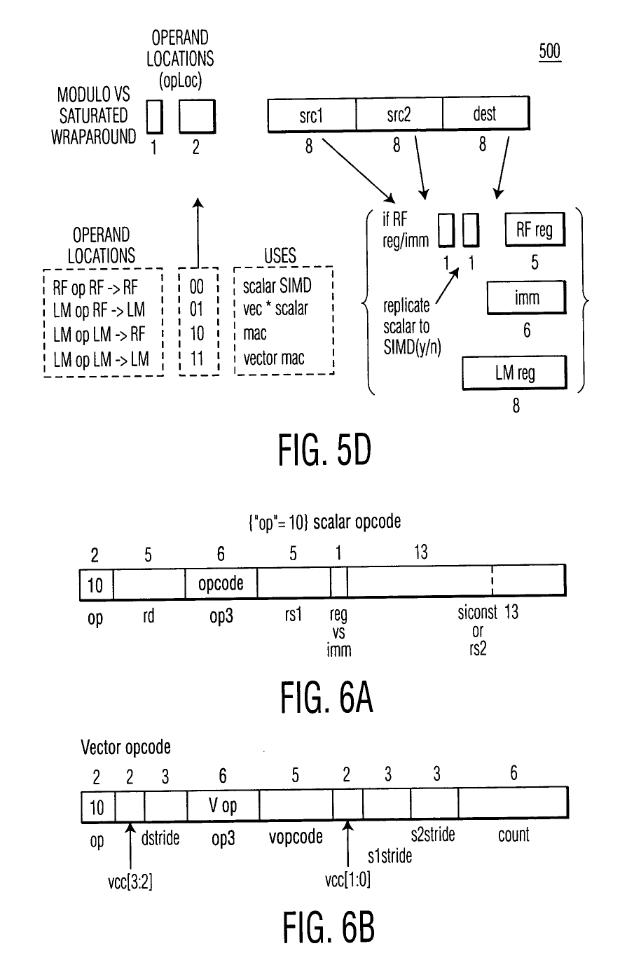

Referring now to FIGS. 5a-c, there is shown three different instruction formats. FIG. 5a shows the call displacement instruction group which is identified by the “op” bitfield=01. The call displacement instruction group is not changed by the present invention. FIG. 5b shows the SETHI (set high) and conditional branches instruction group, which is identified by the “op” bitfield=00 and the “op2” bitfield. The “op” bitfield is 2 bits wide and the “op2” bitfield is 3 bits wide.

FIG. 5c shows the remaining instructions identified by the “op” bitfield=10 or 11. The instructions shown use the “op3” bitfield, which is 6-bits wide. As will be described later, the “op3” bitfield is a scalar operation code (opcode).

The present invention uses the “op” bitfield of “00” and the “op2” bitfield (3 bits) to define a left data path instruction. This left data path instruction provides half of a vector instruction (half instruction word is 32 bits). The “op2” bitfield is shown in Table 1. As shown, 8-bit, 16-bit and 32-bit SIMD (single instruction multiple data) operations are added by the present invention to determine the vector data size in a vector instruction. It will be appreciated that opcodes already used by SPARC are not changed. The new SIMD vector operations are defined “op2” bitfields. SIMD modes are not added to existing SPARC scalar opcodes, but only to the newly defined vector instructions.

TABLE 1
SIMD Vector Operations added to the SETHI and
conditional branches instruction group (op = 00).

| “op2” | |
|---|---|
| bitfield | Opcode |
| 000 | unimpemented |
| 001 | 8-bit SIMD vector op (2nd word) |
| 010 | Bicc (conditional branch int unit) |
| 011 | 16-bit SIMD vector op (2nd word) |
| 100 | SETHI |
| 101 | 32-bit SIMD vector op (2nd word) |
| 110 | FBfcc (condit. branch FPU) |
| 111 | CBccc (condit. branch CoP) |

After decoding the five bits (“op” and “op2”) and determining the sub-word parallelism size (SWpSz), 127 bits remain available in the left data path 32-bit word. The manner in which the remaining 27 bits are defined by the present invention is shown in FIG. 5d. The 27 bits in the 32-bit word, shown in FIG. 5d, are generally designated by 500. As shown, 24 bits are used for the three operands, namely source 1 (src 1), source 2 (src 2) and destination (dest). One bit, for example, is used to identify modulo or saturated wraparound value in a register (modulo/saturated is meaningful for all vector arithmetic operations except vmul and vmac). Again, only vector operations have the modulo/saturation bit which is useful for DSP calculations. This capability is not added to existing SPARC opcodes.

The remaining two bits, as shown for example, are used to identify the location of the operands. A “00” operand location defines that both the source operands and destination operand are located in the internal registers (r-registers, or register files 34a and 34b in FIG. 1). Using the register file for all operands of a vector operation is called a “scalar SIMD” operation. Note that, inspite of the name, this is a vector opcode; and such an operation has the normal vector latencies. Also note that this operation operates on 64 bit operands; so, even-numbered registers must be specified. A “01” operand location defines that one source operand is located in the LM registers (LM 26 and 28 in FIG. 1), the other source operand is located in the r-registers, and the destination operand is location in the LM registers. A “10” operand location defines that both source operands are in the LM registers and the destination operand is in the r-registers. Lastly, a “11” operand location defines that all three operands are located in the LM registers. It will be appreciated that such an operation location may be used during a vector multiply accumulate (vmac) instruction.

Still referring to FIG. 5d, each of the operands includes 8 bits to identify 256 LM registers (via the LM PTT shown in FIG. 4) or 5 bits to identify 32 r-registers. If the operands are in the r-registers, one additional bit is used to identify whether the operand is regular or immediate (constant). One further bit is used to indicate whether to replicate or not replicate a scalar value across the entire SWP word. That is, a value, which fits inside the current sub-word size and which is found in the least-significant sub-word position of the operand, will be copied into all the other sub-words if the replication bit is set. For example, if an SWP size of 16 bits is specified, replication will copy the contents of bit 15-0 into {bits 63-48, bits 47-32, and bits 31-16} prior to performing the specified vector opcode.

Having completed description of the second word (32-bit word in the left data path), the first word (32-bit word in the right data path) will now be described. Referring to FIGS. 6a and 6b, there are shown a scalar opcode, being a 32-bit word used in the SPARC ISA, and a vector opcode (the first word), being a modification of the scalar opcode. As shown, the first word is a 32-bit word for execution by the right data path. It will be appreciated that the first word and the second word together form a vector instruction, in accordance with an embodiment of the present invention.

The scalar opcode word, shown in FIG. 6a, includes “op”=10 (or 11) and “op3” which defines the scalar opcode using six bits. The destination operand (rd) is 5 bits wide, the first source operand (rs1) is 5 bits wide, and the second source operand (rs2) is 5 bits wide (shown in the 13 bits position). As also shown, 13 bits may be used as a signed constant, when so defined by one bit (register/immediate). This 32-bit scalar opcode word is also illustrated in FIG. 5c as being in the “op”=10 group.

The present invention defines two of the unused opcodes of the SPARC scalar instruction set to be vector opcodes, as exemplified in FIG. 6b. The invention names these opcodes “Vop1” and “Vop2”, in correspondence with the “Cop” opcode of the basic SPARC instruction set. In the example shown, the “op” bitfield of the vector opcode is the same as the “op” of the corresponding scalar opcode. Vop1 and Vop2 are defined by placing the bit patterns “101110” and “101111”, respectively, into the 6 bits of the “op3” bitfield. The remaining 24 bits (non-opcode bits) are available for vector control. It will be appreciated that the two source operands and the destination operand, according to the invention, are placed in the second word (left data path) and are not needed in the first word (right data path). As a result, these remaining 24 bits are available for vector control.

The 24 non-opcode bits, shown in FIG. 6b as an example, may be used as follows:

vector count—6-bits;

source 1 (s1) stride—3 bits;

source 2 (s2) stride—3 bits;

destination (d) stride—3 bits;

vector conditional code (vcc)—4 bits; vcc [3:0];

vector operation code (vopcode)—5 bits;

The vector strides are each 2³ (or 0-7) 64-bit words. A stride of zero means “use as a scalar”. In another embodiment of the invention, the contents of the stride bitfield may access a lookup table to define a more relevant set of strides. For example, the 8 possible strides may be: 0, 1, 2, 3, 4, 8, 16, and 32.

The vcc [3:0] defines the conditional test to be performed on each element of the vector. The tests have the same definition as those in the SPARC “branch on integer condition codes” (Bicc) instruction, except that they are applied to multiple elements and the results are kept in the vector “bit mask” register. Whether or not the bit mask register is read or written depends on the “cc” bit of VopN. That is, a vector operation whose “op3” bitfield is Vop1 does not read or write the mask register; a bitfield of Vop2 does. This is discussed in detail below.

The present invention defines the vector operation as a 5-bit field (vopcode in FIG. 6b). With a 5-bit field, 32 possible vector operations (vopcodes) may be defined. Since hardware efficiency is always an issue, the bit patterns of the various vopcodes are assigned by the present invention to correspond to the same bitfields of the “op3” field in the scalar opcodes. In this manner, the invention advantageously requires very little extra hardware to translate the vector operation into the actual scalar operation that is iterated by the data path.

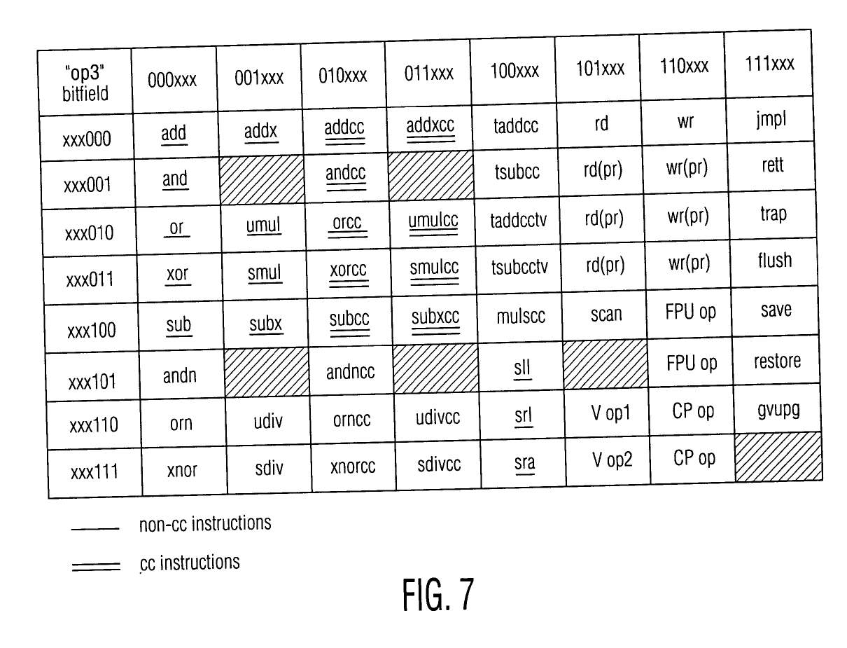

Referring now to FIG. 7, there is shown scalar instructions that are directly equivalent to vector instructions, with non-cc instructions underlined once and cc instructions underlined twice. Both sets (non-cc instructions and cc instructions) add up to 21 vector opcodes (out of 32 possible with a 5-bit field).

Vop1 and Vop2 in FIG. 7 are added as “op3” bitfields 101110 and 101111. Vop1 is used for vector operations that do not activate a cc flag and Vop2 is used for instructions that activate the cc flag. Vop1 and Vop2 may be placed in the vector opcode word at positions shown in FIG. 6b. It will be understood that Vop1 or Vop2 in the vector opcode word informs the processor that the vector opcode word (first word in the right data path) is to be interlocked with the second word in the left data path. In this manner, both words (64 bits) are used to define a single vector operation. The first word provides the vopcode (5-bits) bitfield and vector control bitfields, whereas the second word provides the source operands and the destination operand, as well as the vector data size.

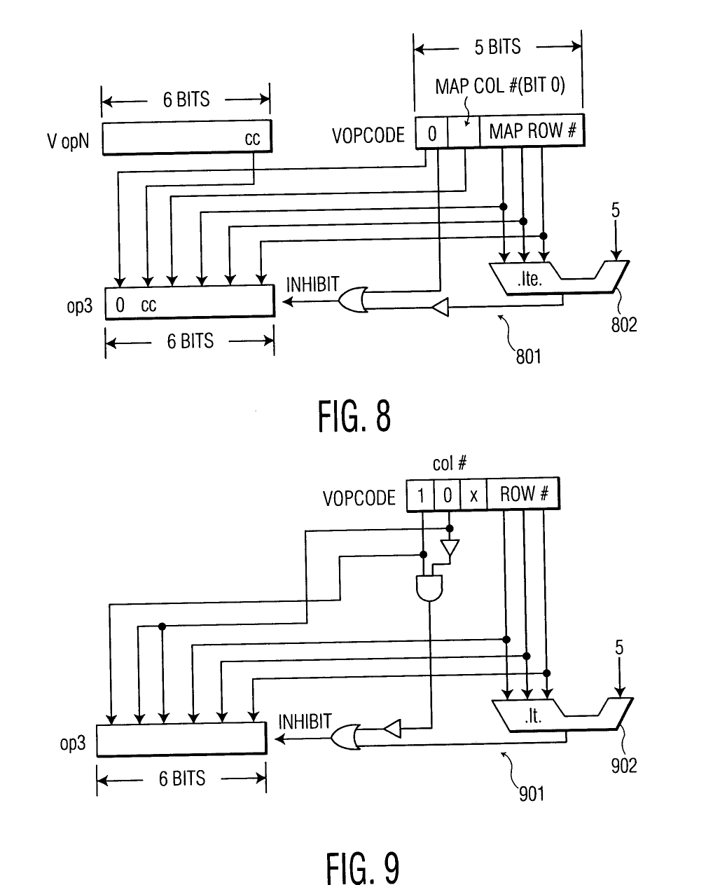

It will be appreciated that, except for the three shift opcodes (sll, srl, sra), the cc/not cc aspect of the opcodes of interest in FIG. 7 are directly controlled by bit 4 (in other words, ______x______) of “op3”. As a result, bit 0 (i.e. ______x) of VopN (Vop1 or Vop2) may be directly mapped to the cc bit of “op3”. This mapping is shown in FIG. 8. As shown, the cc bit of VopN may be mapped to the cc bit of “op3” (bit position 4). Bit position 4 of vopcode (i.e. 0 ______) may be mapped to bit position 5 of “op3”, as shown. Therefore, only four bits of vopcode need be used to directly map 18 vector operations (first four columns in FIG. 7). Four more unassigned (shown shaded) bit patterns of “op3” may also be mapped without contradiction.

The remaining ten operations (shown at the bottom of the four leftmost columns of FIG. 7) may be inhibited with the wiring pattern shown in FIG. 8 to prevent decoding conflicts. As shown, inhibitor logic circuit 801 includes comparator 802, which is activated if the row number is greater than 5, where the topmost row number is zero.

Table 2 below shows the vopcode bitfields implemented, as an example, by the present invention as a 5-bit vopcode, and is shown positioned adjacent to the Vop bitfield of the first word in FIG. 6b. Each of the entries in the “00xxx” and “01xxx” columns represents two opcodes (one with cc and one without cc), when used with VopN (Vop1 is without a cc flag and Vop2 activates the cc flag). Each of the entries in the “10xxx” and “101xx” columns represents one opcode (without cc) and is used with Vop1 only (Vop1 is without a cc flag).

It will be appreciated that the following vector opcodes-vadd, vand, vor, vxor, vsub, vaddx, vumul, vsmul, vsubx, vsll, vsrl and vsra in Table 2 are direct mappings from the scalar “op3” bitfields shown in FIG. 7. The remaining vopcode bitfields in Table 2 do not have correspondence to the scalar “op3” bitfields shown in FIG. 7.

The vumac and vsmac (v=vector; u=unsigned; s=signed; mac=multiply accumulate) are new vector instructions.

TABLE 2
Vopcode Bitfields

| | | |
|---|---|---|
| | Entries represent | |
| | 2 opcodes | Entries represent |
| vopcode | (uses VopN bit) | 1 opcode |

| bitfield | 00xxx | 01xxx | 10xxx | 101xx |
|---|---|---|---|---|
| xx000 | vadd | vaddx | vunpkl | |
| xx001 | vand | vumac | vunpkh | lm_lut |
| xx010 | vor | vumul | vrotp | |
| xx011 | vxor | vsmul | vrotn | |
| xx100 | vsub | vsubx | vcpab | |
| xx101 | | vsmac | vsll | |
| xx110 | | vumacd | vsrl | |
| xx111 | | vsmacd | vsra | |

Since these instructions use cc flags, they are placed in the “01xxx” column of Table 2 which corresponds to the unused cc-dependent bit patterns of FIG. 7. Mac instructions using double-precision (d) accumulators, namely vumacd and vsmacd, occupy two additional opcodes in the “01xxx” column of Table 2.

It will be appreciated that a special decoder (not shown) may be used for vsmac, vumacd and vsmacd, because the decoder shown in FIG. 8 inhibits all rows having a value greater than 5.

A special decoder is used for the three shift opcodes (vsll, vsrl and vsra), as shown in FIG. 9. As shown, inhibitor circuit 901 includes comparator 902, which inhibits decoding unless the opcode row number is greater than or equal to 5 (bottom input to inhibitor OR gate) and the opcode column number is “10x” (top input to inhibitor OR gate).

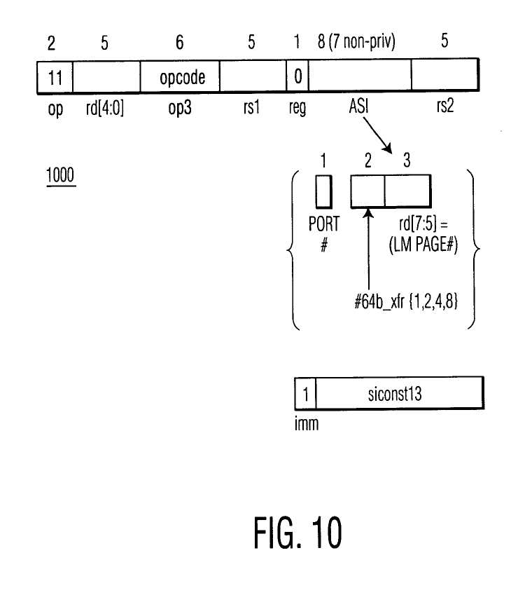

In an embodiment of the invention, FIG. 10 depicts a vector load/store instruction, generally designated as 1000. As shown, the vector instruction includes a 32-bit word, which in size is similar to a scalar load/store instruction, shown in FIG. 6a. The two source operands (rs1, rs2) are each 5 bits, allowing for identifying a source register in memory. The destination operand (rd) is 5 bits, allowing for identifying a destination register in memory.

The “op” bitfield is “11” and the “op3” bitfield is 6 bits wide, defining the vector load/store opcodes. These load/store opcodes are shown in Table 3. The vector load packed/store packed (Idp/stp) opcodes may be seen in columns “001xxx”, “011xxx” and “101xxx”. It will be appreciated that “sb” is signed byte, “ub” is unsigned byte, “sh” is signed half word, “uh” is unsigned half word, “Idpd” is load packed double word and “stpd” is store packed double word.

Still referring to FIG. 10, the “reg/imm” bitfield specifies whether the operands are vector or scalar registers (0) or immediates (1). An immediate may include a 13-bit signed constant (siconst13). An immediate Idpxx implies a LM page number 0, the physical CPU memory port associated with the virtual LM page, and a transfer block size of 1. This makes LM page 0 special. The “Idp-immed” instructions can randomly load registers in only this page. The various formats of “Idpxx-immed” replicate the immediate constant into all SWP subwords, as defined by the “xx” suffix.

LM pages have an ASI, so that they can be located by the MMU. The address space identifier (ASI) bitfield may include, as shown, one bit identifying either the left or right LM's memory port, 3-bits identifying the LM page number (page number 1-8), and the transfer block size (1, 2, 4, 8), where the basic unit of transfer is 64 bits.

TABLE 3
Load/store Opcodes (6-bits)

| “op3” | | | | | | | | |
|---|---|---|---|---|---|---|---|---|
| bitfield | 000xxx | 001xxx | 010xxx | 011xxx | 100xxx | 101xxx | 110xxx | 111xxx |
| xxx000 | ld | | lda | | ldf | ldp | ldc | |
| xxx001 | ldub | ldsb | lduba | ldsba | ldfsr | ldpub | ldcsr | |
| xxx010 | lduh | ldsh | lduha | ldsha | | ldpuh | | |
| xxx011 | ldd | ldpsb | ldda | ldpsh | lddf | ldpd | lddc | |
| xxx100 | st | stpsb | sta | stpsh | stf | stp | stc | |
| xxx101 | stb | ldstub | stba | ldstuba | stfsr | stpub | stcsr | |
| xxx110 | sth | | stha | | stbfq | stpuh | scdfq | |
| xxx111 | std | swap | stda | swapa | stdf | stpd | scdf | |

Data is kept in different forms depending on whether it is located in DRAM or in LM. For certain types of data, leading zeros of the LM format can be automatically removed for transfer to DRAM, and automatically restored upon the reverse transfer. This management of zeros saves space in DRAM.

Data formats for loads/stores are presented in Tables 4 and 5. Table 4 shows the effects of various types of loads on the data formats, and Table 5 shows the effects of various types of stores on the data formats. DRAM formats and LM formats are shown. Stores/loads in the LM take one clock cycle. Stores/loads in the DRAM, which require alignment by a rotator, take two clock cycles.

TABLE 4
Effects of Various Types of Loads on Data Formats

| opcode | In-DRAM format | | LM format | |
|---|---|---|---|---|
| ldp(u/s)b | 8 × 8 bit | (unaligned fixed | 8 × 16 bit | (2:1 zero/sign |
| | | by rotator) | | extend) |
| ldp(u/s)h | 4 × 16 bit | (unaligned fixed | 4 × 32 bit | (2:1 zero/sign |
| | | by rotator) | | extend) |
| ldp | 1 × 32 bit | (exactly 32 bits, | 1 × 32 bit | (any 32-bit |
| | | else coherence | | boundary in LM, |
| | | issue) | | no extensions) |
| ldpd | 64 bit | (unaligned fixed | 64 bit | (no extensions) |
| | | by rotator) | | |

TABLE 5
Effects of Various Types of Stores on Data Formats

| opcode | LM format | In-DRAM format | |
|---|---|---|---|
| stp(u/s)b | 8 × 16 bit | 8 × 8 bit | (saturated; unaligned allowed) |
| stp(u/s)h | 4 × 32 bit | 4 × 16 bit | (saturated; unaligned allowed) |
| stp | 1 × 32 bit | 1 × 32 bit | (must tell DRAM this r/m/w) |
| stpd | 1 × 64 bit | 1 × 64 bit | (unaligned write is allowed) |

The following applications are being filed on the same day as this application (each having the same inventors):

CHIP MULTIPROCESSOR FOR MEDIA APPLICATIONS; TABLE LOOKUP INSTRUCTION FOR PROCESSORS USING TABLES IN LOCAL MEMORY; VIRTUAL DOUBLE WIDTH ACCUMULATORS FOR VECTOR PROCESSING; CPU DATAPATHS AND LOCAL MEMORY THAT EXECUTES EITHER VECTOR OR SUPERSCALAR INSTRUCTIONS.

The disclosures in these applications are incorporated herein by reference in their entirety.

Although illustrated and described herein with reference to certain specific embodiments, the present invention is nevertheless not intended to be limited to the details shown. Rather, various modifications may be made in the details within the scope and range of equivalents of the claims without departing from the spirit of the invention.

What is claimed:

1. In a processing system, including left and right data path processors configured to execute instructions issued from an instruction cache, a vector instruction comprising
a first word configured for execution by the left data path processor,
a second word configured for execution by the right data path processor,
the first and second words issued in the same clock cycle from the instruction cache, and interlocked to jointly specify a single vector instruction, and
the first and second words including code for vector operation and code for vector control,
wherein the first and second words are concurrently executed to complete the vector operation, free-of any other instructions issued from the instruction cache.

2. The vector instruction of claim 1 wherein
the second word includes first and second source operands and a destination operand, and
the first word includes the vector operation code for operating on the first and second source operands and providing a result of the vector operation code in the destination operand.

3. The vector instruction of claim 2 wherein
the first word includes a vector count for controlling the number of repetitions in executing the vector operation code, and
a vector stride for each of the source and destination operands for controlling stride in memory for each of the source and destination operands.

4. The vector instruction of claim 3 wherein
the first word includes a condition code for preparing a vector mask based on results of the vector operation code.

5. The vector instruction of claim 4 wherein
the first word includes a flag for activating the condition code.

6. The vector instruction of claim 3 wherein
the second word includes a field for specifying an operand location, the operand location being in an internal global register or in an external local memory register.

7. The vector instruction of claim 3 wherein
the second word includes a flag for specifying one of modulo arithmetic and saturated arithmetic.

8. The vector instruction of claim 1 wherein
the first and second words are modified instruction words of a reduced instruction set computer (RISC) architecture.

9. The vector instruction of claim 8 wherein
the RISC architecture is a SPARC instruction set architecture (ISA) having a set of scalar operation codes, and
the vector operation code is obtained from a set of vector operation codes that are a re-mapping of the set of scalar operation codes.

10. In a processing system including at least first and second processors, an instruction set architecture (ISA) for executing vector and scalar operations comprising
first instruction words configured for execution by the first processor,
second instruction words configured for execution by the second processor,
each of the first and second instruction words configured as an independent scalar operation for separate execution by each of the first and second processors, and
each of the first and second instruction words interlocked together as a vector operation for joint execution by each of the first and second processors,
wherein, when executing scalar operations, the first and second processors use the first and second instruction words to concurrently execute two independent scalar operations, and
when executing vector operations, the first and second processors interlock the first and second instruction words to execute a single vector operation.

11. The processing system of claim 10 wherein
each of first and second instruction words includes a scalar operation code, when the first and second instruction words are executed independently of each other,
one of first and second instruction words includes a vector operation code, when the first and second instruction words are interlocked together, and
the vector operation code is one of a set of vector operation codes that are a re-mapping of a set of scalar operation codes, the scalar operation code being one of the set of scalar operation codes.

12. The processing system of claim 10 wherein
the first and second instruction words interlocked together to execute a single vector operation include
first and second source operands and a destination operand, and
a vector operation code for operating on the first and second source operands and providing a result of the vector operation code in the destination operand.

13. The processing system of claim 12 wherein
the first and second instruction words interlocked together to execute the single vector operation include
a vector count for controlling the number of repetitions in executing the vector operation code, and
a vector stride for each of the source and destination operands for controlling stride in memory for each of the source and destination operands.

14. The processing system of claim 12 wherein
the first and second instruction words interlocked together to execute a single vector operation include
a condition code for preparing a vector mask based on results of the vector operation code.

15. The processing system of claim 10 wherein
each of first and second instruction words is an instruction word obtained from a reduced instruction set computer (RISC) architecture, and
the first and second instruction words interlocked together to execute a single vector operation include bitfields incorporated into unused bitfields in first and second instruction words obtained from the RISC architecture.

16. The processing system of claim 15 wherein
the RISC architecture is a SPARC instruction set architecture (ISA) having a set of scalar operation codes, and
the first and second instruction words interlocked together to execute a single vector operation include bitfields incorporated into unused bitfields in first and second instruction words obtained from the SPARC ISA.

17. A method of modifying a reduced instruction set computer (RISC) architecture having multiple scalar instruction groups for executing scalar operations into a vector instruction group for executing vector operations, the method comprising the steps of:
a. defining a first instruction word belonging in a first scalar instruction group as half of a vector single-instruction-multiple-data (SIMD) operation code, in which the operation code determines a sub-word parallelism size (SWPSz);
b. adding bitfields to the first instruction word, the bitfields representing two source operands and one destination operand;
c. deleting bitfields representing two source operands and one destination operand from a second instruction word belonging in a second scalar instruction group;
d. defining vector control bitfields for a vector operation;
e. substituting the vector control bitfields defined in step (d) for the bitfields deleted in step (c); and
f. interlocking together the first instruction word and the second instruction word to form a double word for executing a vector instruction.

18. The method of claim 17 wherein
step (d) includes defining a vector operation code for operating on the first and second source operands and providing a result of the vector operation code in the destination operand, and
defining a vector count for controlling the number of repetitions in executing the vector operation code.

19. The method of claim 18 wherein
step (d) includes defining a vector stride for each of the source and destination operands for controlling stride in memory for each of the source and destination operands.

20. The method of claim 19 wherein
step (d) includes defining a condition code for preparing a vector mask based on results of the vector operation code.
